(19) United States
(12) Patent Application Publication
(10) Pub. No.: US 2007/0103478 A1
(43) Pub. Date: May 10, 2007

(54) Display device and display method of monitor

(75) Inventor: Jui-Hsiang Lin, Taipei (TW)

Correspondence Address: TROXELL LAW OFFICE PLLC;Suite 1404, 5205 Leesburg Pike, Falls Church, VA, 22041, US

(73) Assignee: Ronmee Industrial Corporation

(21) Appl. No.: 11/269,733

(22) Filed: Nov. 9, 2005

(51) Int. Cl. G06F 12/06

(52) U.S. Cl. 345/571

(57) ABSTRACT

The present invention relates to a display device and a display method of a monitor. The display device comprises a plurality of memories for receiving a plurality of exterior video images via an input buffer, the memories being coupled to a wide-area X-axial address line and a wide-area Y-axial address line so as to form memory arrays by addressing; and a plurality of display cells for receiving the video images via an input/output buffer, the display cells being connected to the memories via local-area X-axial address lines and local-area Y-axial address lines so as to form display cell arrays, each display cell array being corresponding to a single memory array. The video images are divided into several blocks fictitiously and stored in the memory arrays. The video images, which are stored in the memory arrays, can be shown on the monitor via corresponding display cell arrays.

### FIELD OF THE INVENTION

The present invention relates to a display device and a display method of a monitor, and more practically to a display method that fictitiously divides video images into several blocks and stores them in memory arrays. By simultaneously addressing to several memory arrays, the required scan time for every column can be shortened such that the resolution of the video image can be increased and the flicker phenomenon caused by the progressive scan can be decreased so as to effectively shorten the response time of the flat panel monitor.

### BACKGROUND OF THE INVENTION

The conventional CRT monitor utilizes the interlaced scan for display, and the flat panel monitor utilizes the progressive scan for display. In these two scan methods, the screen is scanned continuously from let to right and from up to down in a line-by-line scan manner, wherein if the refresh frequency of the CRT monitor is too slow, the user will feel that the screen is flickering and shaking. According to VESA specification, if the resolution is 640×480, the vertical scan frequency should be at least 72 Hz basically. If the screen requires higher resolution, the vertical scan frequency must be larger than 85 Hz so as to obtain the stable screen frame, which produces no flicker phenomenon and is harmless to the eyes. The flat panel monitor has 30 ms response time, which is significantly smaller than the required time (16.7 ms) for dynamically displaying images. Accordingly, ghost images and image sticking problems are caused.

However, with the increase in monitor's size, higher resolution is required. As a result, for the CRT monitor, the refresh frequency must be increased significantly. Similarly, for the flat panel monitor, the electrodes, which are located near the center of the monitor, have longer response time. In order to obtain synchronized display, the integral response time of the monitor is thus slow down. Consequently, the monitor's size and the monitor's image quality are confined to one another.

### SUMMARY OF THE INVENTION

The major object of the present invention is to provide a display device and a display method of a monitor, wherein video images are divided into several blocks fictitiously and stored in memory arrays. At the beginning of every addressing period, all column addresses of these blocks are generated simultaneously, and they can be addressed to several memory arrays simultaneously such that the required scan time for every column can be decreased. As a result, the resolution of the video image can be increased, and the flicker phenomenon caused by the progressive scan can be decreased so as to shorten the response time of the flat panel monitor effectively.

### BRIEF DESCRIPTION OF THE DRAWINGS

FIG. 1 is a block diagram showing the configuration of the display device of the present invention.

FIG. 2 is a schematic diagram showing the configuration of the memories of the present invention.

FIG. 3 is a schematic diagram showing the configuration of the display cell arrays of the present invention.

FIG. 4 is a schematic diagram showing the division modes of the video images in accordance with the present invention.

### DETAILED DESCRIPTION OF THE PREFERRED EMBODIMENT

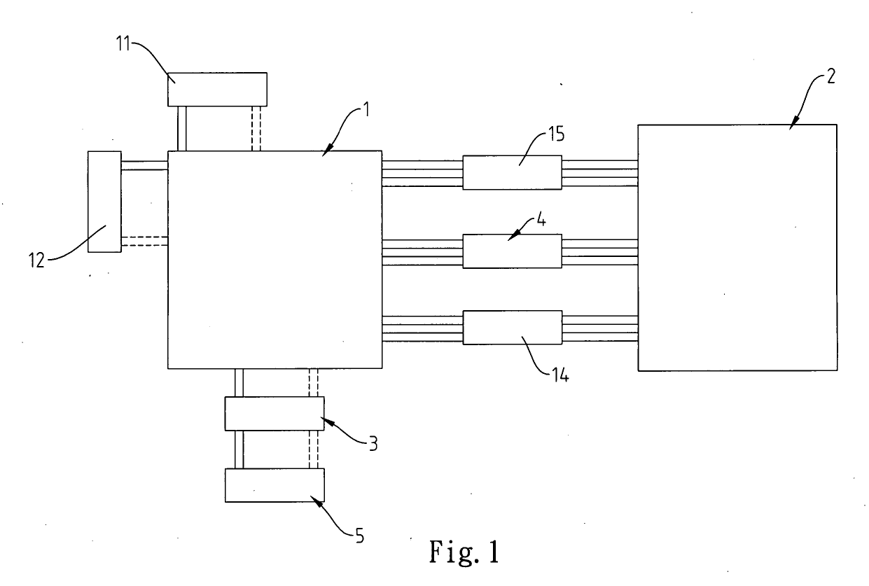

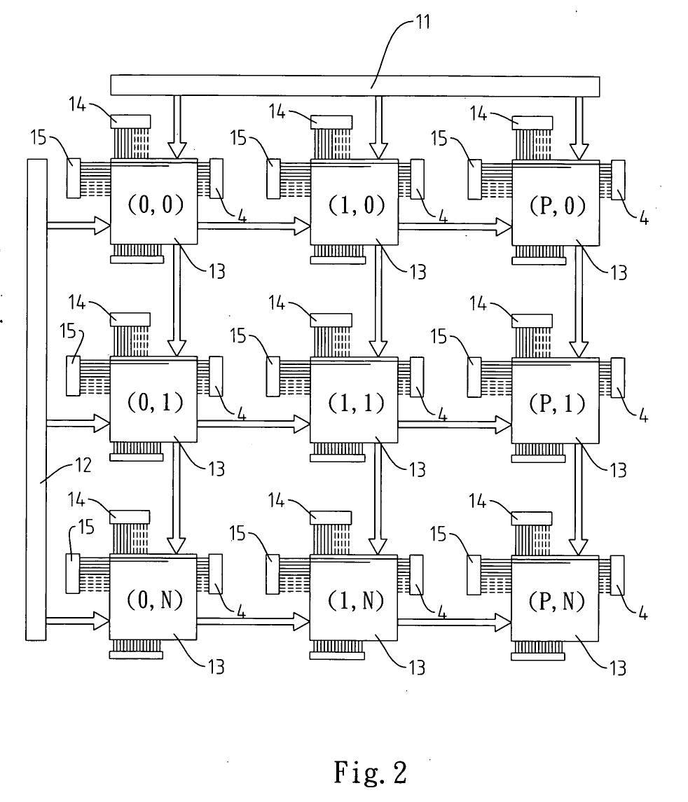

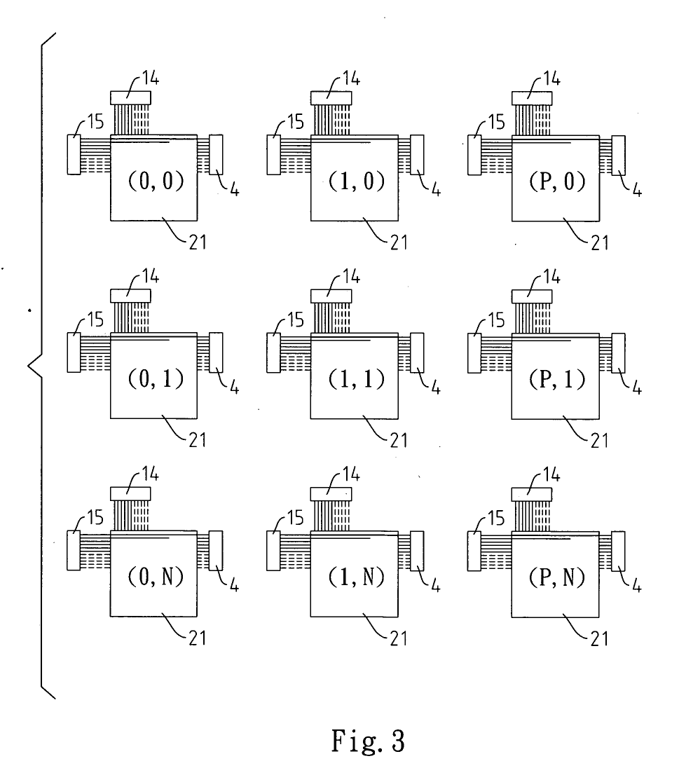

Referring to FIG. 1, FIG. 2 and FIG. 3, a display device and a display method of a monitor of the present invention is illustrated. As shown in FIG. 1, the display device of the monitor comprises memories 1 and display cells 2. The memories 1 are designed to receive video images 5 from the external world via an input buffer 3, and the memories 1 are coupled to a wide-area X-axial address line 11 and a wide-area Y-axial address line 12, wherein the wide-area X-axial address line 11 has p address lines, and the wide-area Y-axial address line 12 has n address lines. The memories 1 are addressed by use of the wide-area X- and Y-axial address lines to constitute memory arrays 13 that have p*n memory units (as shown in FIG. 2). The received video images 5 are temporarily stored in designated corresponding locations of the memory arrays 13 after being edited.

The memories 1 are connected to the display cells 2 by local-area X-axial address lines 14 and local-area Y-axial address lines 15, wherein the local-area X-axial address lines 14 have p address lines, and the local-area Y-axial address lines 15 have n address lines. The display cells 2 are addressed by use of the local-area X- and Y-axial address lines so as to form display cell arrays 21 (as shown in FIG. 3). Each display cell array 21 is corresponding to a single memory array 13, and receives the video images 5 from this memory array 13 via an input/output buffer 4.

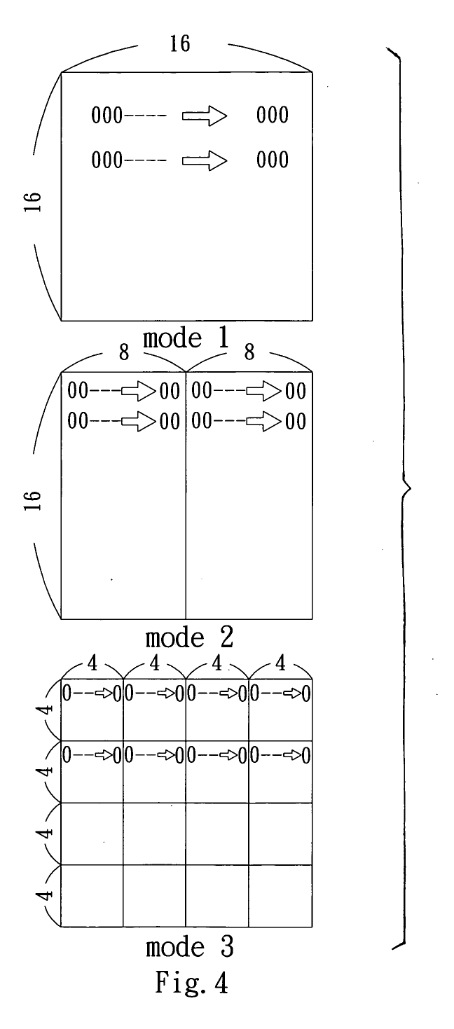

Referring further to FIG. 4, the general monitor displays images in a line-by-line scan manner (e.g. mode 1), namely the screen is continuously scanned from let to right and from up to down in the line-by-line scan manner. When the size of the monitor is enlarged, the required scan time will be correspondingly increased. As a result, the flicker phenomenon is easily formed on the screen frame.

As shown in FIG. 4, the block scan method disclosed in the present invention is to divide the screen into several blocks fictitiously so as to form various division modes. For example, in the mode 1, the monitor has a matrix-type display screen consisting of 16*16 pixels. As shown in mode 2, when two blocks are formed by fictitiously dividing the screen, every fictitious block becomes a matrix-type block consisting of 8*16 pixels. As a result, the required scan time can be half shortened by X-axially scanning these two blocks simultaneously. In addition, as shown in mode 3, the screen is fictitiously divided into 16 blocks along column and row directions. As a result, relative to the mode 1, X-axially scanning these 16 blocks simultaneously requires only 1/4 scan time.

The selection of the above-mentioned blocks consists in addressing correctly. As described above, the wide-area X-axial address line 11 has p address lines, and the wide-area Y-axial address line 12 has n address lines. The memories 1 are addressed via the wide-area X- and Y-axial address lines to constitute memory arrays 13 that have p*n memory units (as shown in FIG. 2). The received video images 5 are temporarily stored in designated corresponding locations of the memory arrays 13 after being edited, and they are addressed progressively by p+1 via the wide-area X-axial address line 11 (i.e. 0, P+1, 2p+1 . . . ) so as to correspond to their respective blocks in this column. As a result, they can be addressed, respectively, to obtain the memory arrays 13 (0,0), (1, 0) . . . (n,0). For the same reason, the received video images can be respectively addressed by n+1 via wide-area Y-axial address line 12 so as to obtain the memory arrays 13 (0,0), (1, 1) . . . (p,n) according to the addresses (0, n+1, 2n+1 . . . ) of the columns. Thereafter, by scanning the columns of the fictitious blocks in the line-by-line scan manner and using the local-area address lines, the video images 5, which are stored in the memory arrays 13, can be shown on the monitor via the corresponding display cell arrays 21.

It is worth to note that all column addresses of these blocks are generated simultaneously at the beginning of every addressing period of the wide-area axial address lines. In other words, they can be addressed to several memory arrays 13 simultaneously. By scanning the local-area axial address lines, the display cell arrays 21 (p*n) can be lighted up simultaneously. Moreover, the action of the wide-area axial address lines and the local-area axial address lines of the memory arrays 13 are synchronous or asynchronous. When they are asynchronous, several different screen frames can be shown on the monitor, respectively.

What the invention claimed is:

1. A display device of a monitor comprising:
a plurality of memories for receiving a plurality of exterior video images via an input buffer, the memories being coupled to a wide-area X-axial address line and a wide-area Y-axial address line so as to form memory arrays by addressing; and
a plurality of display cells for receiving the video images via an input/output buffer, the display cells being connected to the memories via local-area X-axial address lines and local-area Y-axial address lines so as to form display cell arrays, each display cell array being corresponding to a single memory array.

2. A display method of a monitor comprising the following steps:
dividing an image unit into p*n matrix-type image blocks fictitiously and storing them in memory arrays;
using a wide-area X-axial address line for addressing by p+1 so as to correspond to the memory arrays;
using local-area X-axial address lines to scan every display cell array block horizontally, and showing video images, which are stored in the memory arrays, on the monitor via corresponding display cell arrays;
using local-area Y-axial address lines to scan every display cell array block vertically; and
using a wide-area Y-axial address line for addressing by n+1 so as to correspond to the memory arrays.

3. The display method of the monitor of claim 2, wherein the local-area X-axial address lines of the blocks are scanned synchronously.

4. The display method of the monitor of claim 2, wherein the local-area X-axial address lines of the blocks are scanned asynchronously.
